(19) United States
(12) Patent Application Publication
(10) Pub. No.: US 2012/0315422 A1
(43) Pub. Date: Dec. 13, 2012

(54) Label Pad and Related Methods

(76) Inventors: Eric J. Cushing, Los Angeles, CA (US); Anahit Tataryan, Arcadia, CA (US)

(21) Appl. No.: 13/157,302

(22) Filed: Jun. 9, 2011

(51) Int. Cl. C09J 7/02; B32B 38/04; B32B 37/12; C09J 7/04; B32B 33/00

(52) U.S. Cl. 428/41.8; 156/182

(57) ABSTRACT

A label pad including one or more label assemblies and a related method. The label pad has a first label assembly having a first liner portions and a first face portion. The first face portion is positioned over the first liner portion and releasably coupled thereto. The label pad also includes a support, and the first label assembly is positioned over the support. The label pad also includes a first retaining member that is configured to couple at least a portion of the first liner portion of the first label assembly sufficiently to restrain the portion of the first liner portion from separating from the support when the first face portion is peeled away from the support.

### FIELD OF THE INVENTION

The present invention relates generally to adhesive labels and relates more particularly to label pads including adhesive labels.

### BACKGROUND

Adhesive labels are currently used in a variety of venues including, but not limited to, homes, workplaces, and schools. Such adhesive labels typically include a sheet of facestock having a top surface that is receptive to markings or to which a marking-receptive coating is applied and a bottom surface to which a suitable adhesive is applied. In one common type of construction, a plurality of such labels is arranged in an array on a common removable liner. In use, markings are typically made on one or more of the labels, either manually or using an automated printing device, and the labels are then peeled away from the removable liner and adhered to desired substrates.

In another common type of construction, a plurality of adhesive labels is stacked together to form a label pad. Such label pads are currently available in two different varieties, namely, a liner-less variety and a liner-containing variety. In the liner-less variety, the labels are stacked directly on top of one another, with the adhesive coating on the bottom of one label directly contacting the top of the label positioned therebelow. A release coating can be applied to the top surface of each label to enable a top label to be easily peeled away from the label below it. Such labels can include a tabbed portion that can be severably connected to the main portion of each label by perforations. The tabbed portions typically do not have an adhesive coating applied to their respective bottom surfaces, or at least do not have an adhesive coating applied near their respective free ends, to facilitate the grasping of the top label by its tabbed portion so that the top label can be peeled away from the remainder of the pad. In use, markings can be made on the top label, and, then, using the tabbed portion, the top label is peeled away from the remainder of the pad. The label is then adhered to a desired substrate. It should be noted that the adhesive used on such labels is typically a repositionable adhesive. Therefore, if one wishes to remove or reposition the label after the label is adhered to the substrate, one can do so by grasping the tabbed portion and peeling the rest of the label away from the substrate. On the other hand, if one does not intend to remove or to reposition the label, one can tear the tabbed portion away from the rest of the label after the label has been applied to the substrate.

Liner-less label pads of the type discussed above must strike a functional balance between the strength of the adhesive on the bottoms of the labels and the effectiveness of the release coating on the tops of the labels. If the strength of the adhesive is too great, the top label cannot be removed from the remainder of the pad or, even if the top label can be removed, it will curl when it is removed from the remainder of the pad. On the other hand, if the effectiveness of the release coating is too great, it will be difficult to make a marking on the label as the release coating will repel the ink.

A liner-containing label pad avoids the need to strike the above-described balance between adhesive strength and release coating effectiveness by providing each label with its own release liner. As a result, there is no need to provide a release coating on the top of each label. Accordingly, greater flexibility is permitted in the type of adhesive used, the release force of which can be controlled using a suitable release liner. However, the downside to such a construction is that, in order to adhere a label to an object, one must remove the top label from its associated liner, which can be difficult, in order to expose the adhesive.

Thus, there is a need for a label pad that has greater flexibility in terms of the type of adhesive that can be used and that has labels which can be easily removed from the pad to expose the adhesive on the bottom of the removed label.

### SUMMARY

One exemplary embodiment of the invention is a label pad. The label pad includes a first label assembly having a first liner portions and a first face portion. The first face portion is positioned over the first liner portion and releasably coupled thereto. The label pad further includes a support. The first label assembly is positioned over the support. The label pad also further includes a first retaining member that is configured to couple at least a portion of the first liner portion of the first label assembly sufficiently to restrain the portion of the first liner portion from separating from the support when the first face portion is peeled away from the support.

In other, more detailed features of the invention, the support includes a second label assembly. The second label assembly has a second liner portion and a second face portion. The second face portion is positioned over the second liner portion and is releasably coupled thereto. In other, more detailed features of the invention, the second face portion is positioned directly under the first liner portion.

Also, in other, more detailed features of the invention, the support includes a plurality of identical label assemblies stacked directly on top of one another. Each of the identical label assemblies includes a liner portion and a face portion, and the face portion is positioned over the liner portion and is releasably coupled thereto. In other, more detailed features of the invention, the first label assembly is identical to each of the plurality of identical label assemblies. Additionally, in other, more detailed features of the invention, the first retaining member includes a padding compound. In other, more detailed features of the invention, the padding compound is applied to an outside edge of the first liner portion and to an outside edge of the support.

In other, more detailed features of the invention, the first face portion includes a sheet of facestock and an adhesive material. The sheet of facestock has a top surface and a bottom surface. The adhesive material is applied to at least a portion of the bottom surface of the sheet of facestock. In other, more detailed features of the invention, the sheet of facestock includes paper. In other, more detailed features of the invention, the first face portion includes a marking-receptive coating applied to at least a portion of the top surface of the sheet of facestock.

Additionally, in other, more detailed features of the invention, the first liner portion is divided by a first die-cut into two separate liner portions. One of the two separate liner portions is coupled to the first retaining member. In other, more detailed features of the invention, the first liner portion is divided a second die-cut into three separate portions. One of the three separate portions is coupled to the first retaining member. In other, more detailed features of the invention, the first face portion is divided by a first die-cut into two separate face portions. Also, in other, more detailed features of the invention, the first face portion is divided by first and second die-cuts into three separate face portions.

Another exemplary embodiment is a label pad. The label pad includes a stack of identical label assemblies. The stack of identical label assemblies having a top label assembly. Each of the identical label assemblies includes a liner portion and a face portion. The face portion is positioned over the liner portion and is releasably coupled thereto. The face portion is adhesively-backed and marking-receptive. The label pad also includes a first retaining member configured to couple together the stack of identical label assemblies. The first retaining member restrains at least a portion of the liner portion of the top label assembly from separating from the remainder of the stack when a portion of the face portion of the top label assembly is peeled away from the stack.

In other, more detailed features of the invention, each of the identical label assemblies is generally rectangular in shape and includes a first edge, a second edge, a third edge, and a fourth edge. In other, more detailed features of the invention, the first retaining member extends across the first edges of the respective identical label assemblies. Also, in other, more detailed features of the invention, the label pad further includes a second retaining member configured to couple together the stack of identical label assemblies. The second retaining member extends across the second edges of the respective identical label assemblies.

Additionally, in other, more detailed features of the invention, each of the identical label assemblies is generally rectangular in shape and includes a first side edge, a second side edge, a top edge, and a bottom edge. The first retaining member extends in a band across the top edges of the respective identical label assemblies, and the band is spaced inwardly a short distance from the second side edges of the respective identical label assemblies. The face portion is divided by a first die-cut into two separate face portions, and the first die-cut is spaced intermediate to the first retaining member and the first side edges of the respective identical label assemblies. The liner portion is divided by a second die-cut into two separate liner portions, and the second die-cut is spaced intermediate to the first retaining member and the second side edges of the respective label assemblies. In other, more detailed features of the invention, the second die-cut is positioned intermediate to the first retaining member and the first die-cut.

An exemplary method according to the invention is a method for manufacturing a label pad. The method includes providing a providing a facestock, a release liner, and an adhesive material. The method also includes laminating the facestock to the release liner with the adhesive material to form a laminated material having a face portion and a liner portion. Additionally, the method includes forming die-cuts in the face portion and the liner portion and cutting the laminated material into label assemblies. Furthermore, the method includes stacking the label assemblies to form a stack of label assemblies having a first edge and a second edge. The method also includes applying a padding member to the first edge and applying a retaining member to the second edge.

Other features and advantages of the invention will become apparent to those skilled in the art from the following detailed description of the preferred embodiments take in conjunction with the accompanying drawings, which illustrate, by way of example, the principles of the invention, the invention not being limited to any particular preferred embodiment(s) disclosed.

### BRIEF DESCRIPTION OF THE DRAWINGS

These and other features, aspects, and advantages of the present invention will become better understood and appreciated by referring to the following description, appended claims, and accompanying drawings, which are not necessarily drawn to scale, where:

FIG. 1 depicts a top plan view of a first embodiment of a label pad constructed according to the present invention;

FIGS. 2(a) and 2(b) depict enlarged side elevational views of the label pad shown in FIG. 1;

FIGS. 3(a) and 3(b) depict top plan and enlarged side elevational views, respectively, of one of the individual label assemblies shown in FIG. 1;

FIGS. 4(a) and 4(b) depict top plan and enlarged side elevational views, respectively, of the face portion of the label assembly shown in FIG. 3(b);

FIGS. 5(a) and 5(b) depict top plan and enlarged side elevational views, respectively, of the liner portion of the label assembly shown in FIG. 3(b);

FIG. 6 depicts a flowchart, schematically illustrating one method for using the label pad of FIG. 1 according to the present invention;

FIGS. 7(a) through 7(g) depict side views, illustrating various steps in the method shown in FIG. 6;

FIGS. 8(a) and 8(b) depict top plan and enlarged side elevational views, respectively, of a second embodiment of a label pad constructed according to the present invention with the die-cut in the liner portion of the top label assembly shown in phantom in FIG. 8(a);

FIG. 9 depicts an enlarged side elevational view of a label structure that can be produced by peeling an individual label from the label pad of FIGS. 8(a) and 8(b);

FIGS. 10(a) and 10(b) depict top plan and enlarged side elevational views, respectively, of a third embodiment of a label pad constructed according to the present invention with the die-cut in the liner portion of the top label assembly shown in phantom in FIG. 10(a);

FIG. 11 depicts an individual label that has been separated from the label pad of FIGS. 10(a) and 10(b) and that has been applied to an article;

FIGS. 12(a) and 12(b) depict top plan and enlarged side elevational views, respectively, of a fourth embodiment of a label pad constructed according to the present invention with the die-cut in the liner portion of the top label assembly shown in phantom in FIG. 12(a);

FIG. 13 depicts an individual label that has been separated from the label pad of FIGS. 12(a) and 12(b) and that has been applied to an article;

FIGS. 14(a) and 14(b) depict top plan and enlarged side elevational views, respectively, of a fifth embodiment of a label pad constructed according to the present invention with the die-cut in the liner portion of the top label assembly shown in phantom in FIG. 14(a);

FIGS. 15(a) and 15(b) depict top plan and enlarged side elevational views, respectively, of a sixth embodiment of a label pad constructed according to the present invention with the die-cut in the liner portion of the top label assembly shown in phantom in FIG. 15(a);

FIGS. 16(a) and 16(b) depict top plan and enlarged side elevational views, respectively, of a seventh embodiment of a label pad constructed according to the present invention with the die-cuts in the liner portion of the top label assembly shown in phantom in FIG. 16(a);

FIGS. 17(a) and 17(b) depict top plan and enlarged side elevational views, respectively, of an eighth embodiment of a label pad constructed according to the present invention with the die-cut in the liner portion of the top label assembly shown in phantom in FIG. 17(a);

FIGS. 18(a) and 18(b) depict top plan and enlarged side elevational views, respectively, of a ninth embodiment of a label pad constructed according to the present invention with the die-cut in the liner portion of the top label assembly shown in phantom in FIG. 18(a);

FIGS. 19(a) and 19(b) depict top plan and enlarged side elevational views, respectively, of a tenth embodiment of a label pad constructed according to the present invention with the die-cuts in the liner portion of the top label assembly shown in phantom in FIG. 19(a);

FIGS. 20(a) and 20(b) depict top plan and enlarged side elevational views, respectively, of an eleventh embodiment of a label pad constructed according to the present invention with the die-cuts in the liner portion of the top label assembly shown in phantom in FIG. 20(a);

FIG. 21 depicts a top plan view of a twelfth embodiment of a label pad constructed according to the present invention;

FIG. 22 depicts a top plan view of a thirteenth embodiment of a label pad constructed according to the present invention;

FIG. 23 depicts a top plan view of a fourteenth embodiment of a label pad constructed according to the present invention;

FIG. 24 depicts a top plan view of a fifteenth embodiment of a label pad constructed according to the present invention; and

FIG. 25 depicts a flowchart, schematically illustrating one method of manufacturing the label pad of FIG. 1 according to the present invention.

### DETAILED DESCRIPTION

The present invention is embodied in a label pad, and related methods, that includes a liner portion which is removable as a label is removed from the label pad. The apparatuses, products, and methods disclosed in this document are described in detail by way of examples and with reference to the figures, which are not necessarily drawn to scale. Unless otherwise specified, like numbers in the figures indicate references to the same, similar, or corresponding elements throughout the figures. It will be appreciated that modifications to disclosed and described examples, arrangements, configurations, components, elements, apparatuses, methods, materials, etc. can be made and may be desired for a specific application. In this disclosure, any identification of specific shapes, materials, techniques, arrangements, etc. are either related to a specific example presented or are merely a general description of such a shape, material, technique, arrangement, etc. Identifications of specific details or examples are not intended to be, and should not be, construed as mandatory or limiting unless specifically designated as such. A few non-limiting examples of label pads are discussed below.

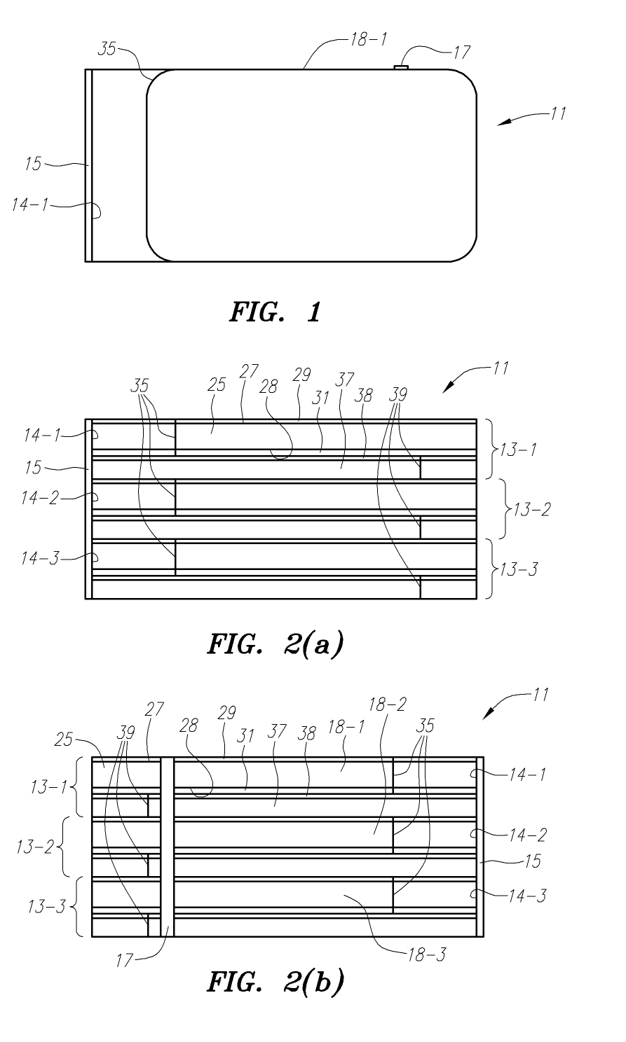

Referring now to FIGS. 1, 2(a) and 2(b), there are shown various views, respectively, of a first embodiment of a label pad constructed according to the present invention, the label pad being represented generally by reference numeral 11.

Label pad 11 can include a plurality of identical label assemblies 13-1 through 13-3, label assemblies 13-1 through 13-3 being arranged in a stack with corresponding structures aligned with one another. For purposes of the present specification and claims, unless otherwise specified, the term “plurality” is defined to mean “two or more.” It is to be understood that, although label pad 11 is shown in the present embodiment including three label assemblies 13-1 through 13-3, the number of label assemblies shown in label pad 11 is merely exemplary, and label pad 11 can have a greater number or lesser number of label assemblies.

For reasons to become apparent below, label assemblies 13-1 through 13-3 are bound together by a padding member 15 covering substantially the entire edges 14-1 through 14-3 of label assemblies 13-1 through 13-3, respectively, and further are bound together by a retaining member 17 extending across a portion of edges 18-1 through 18-3 of label assemblies 13-1 through 13-3, respectively. One or both of padding member 15 and retaining member 17 can be made of any suitable padding compound or other material capable of bonding together a plurality of layered materials via their respective edges. Such padding compounds can include, for example, thermoplastic resins of the type used in automatic padding machines and hot glue guns, such as those sold by Brackett, Inc. (Topeka, Kans.), water-based resin emulsions of the type sold as padding compounds, such as the PRESSLINE-brand padding compound sold by Allied Pressroom Chemistry (Hollywood, Fla.), water-based resin emulsions of the type sold as a craft glue, such as ALEENE'S ORIGINAL TACKY GLUE sold by Duncan Enterprises (Fresno, Calif.), and water-soluble vinyl adhesives of the type sold as padding compounds, such as LITHCO PADDING COMPOUND sold by Lithco, Inc. (Culver City, Calif.).

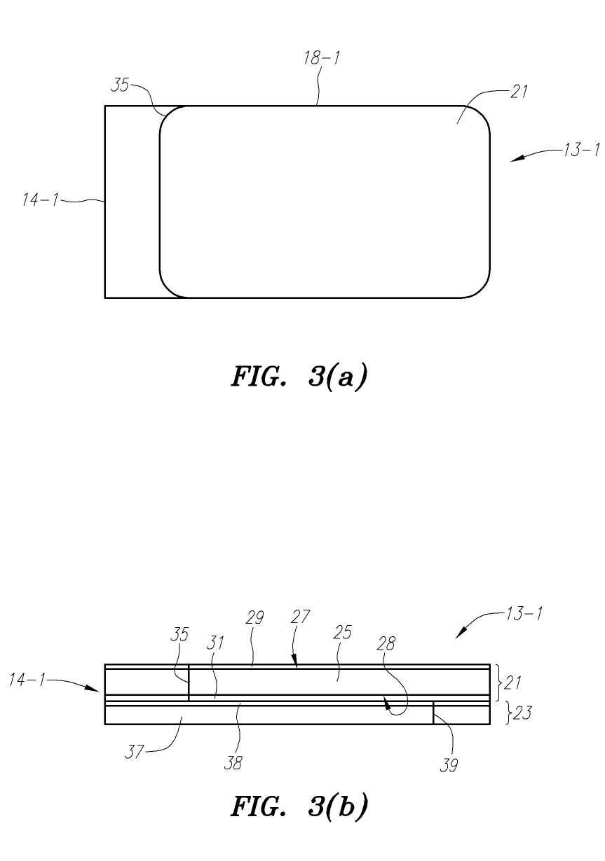

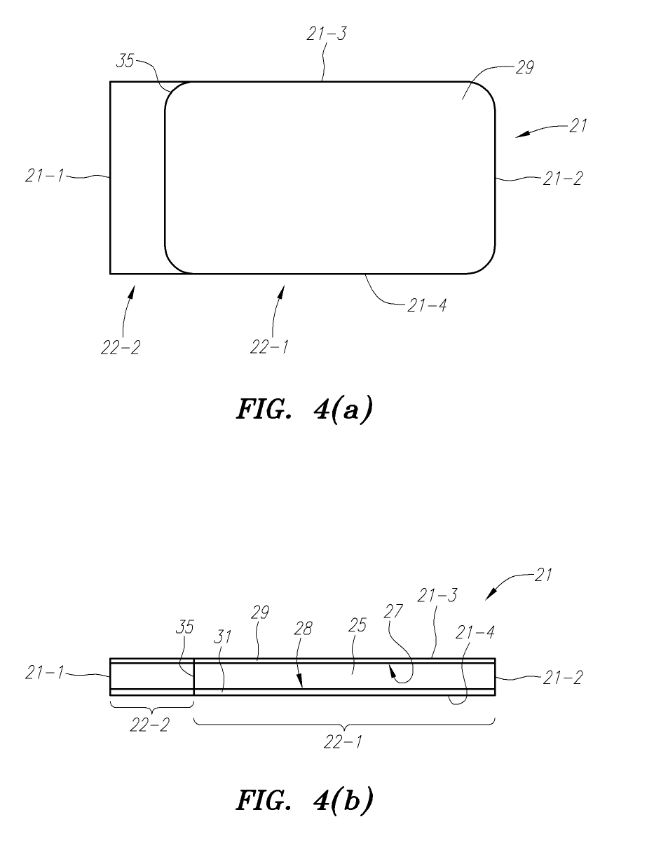

Referring now to FIGS. 3(a) and 3(b), label assembly 13-1 is shown separately (it being understood that label assemblies 13-2 and 13-3 are identical in structure to label assembly 13-1 and that the discussion of label assembly 13-1 that follows is also applicable to label assemblies 13-2 and 13-3). Label assembly 13-1 can include a face portion 21 and a liner portion 23. Face portion 21, which is also shown separately in FIGS. 4(a) and 4(b), can be a generally rectangular multilayer structure shaped to include an edge 21-1, an edge 21-2, an edge 21-3, and an edge 21-4. Face portion 21 can include a sheet of facestock 25 having a top surface 27 and a bottom surface 28. Facestock 25 can be made of a paper, a polymer-coated paper, or a polymeric film. Depending on the type of material used as facestock 25 and depending on the type of marking instrument intended to be used with label pad 11, a marking-receptive coating 29 can be applied to the top surface 27 of facestock 25. Face portion 21 can further include a layer of adhesive material 31 applied directly to the bottom surface 28 of facestock 25. The layer of adhesive material 31 can include, for example, a pressure sensitive adhesive such as a permanent adhesive, a repositionable, removable, or ultraremovable adhesive, or a double-sided adhesive tape. Suitable adhesives include permanent adhesives found in U.S. Pat. No. 5,164,444 to Bernard, which is incorporated by reference herein in its entirety, and repositionable adhesives disclosed in U.S. Pat. Nos. 4,810,763 to Mallya, et al.; 4,944,888 to Mallya, et al.; and 5,656,705 to Mallya, et al., all of which are incorporated by reference herein in their entireties. Other examples of suitable adhesives include E5500 (Avery Dennison Corporation of Pasadena, Calif.), E5560 (Avery Dennison Corporation of Pasadena, Calif.), E5600 (Avery Dennison Corporation of Pasadena, Calif.), PRIMAL EP-5560F (Dow Chemical Company of Midland, Mich.), UR2 (Avery Dennison Corporation of Pasadena, Calif.), MICRONAX 240-00 (Franklin International of Columbus, Ohio), GEL-TAC (Paper Conversions, Inc. (PCI) of Syracuse, N.Y.), COVINAX 210-00 (Franklin International of Columbus, Ohio), and R-423 (Avery Dennison Corporation of Pasadena, Calif.).

Face portion 21 can further include a die-cut 35 that extends at least through marking-receptive coating 29 and facestock 25, and can extend through the layer of adhesive material 31. Die-cut 35 also extends from edge 21-3 of face portion 21 to edge 21-4 of face portion 21, die-cut 35 being spaced a short distance, e.g., approximately 0.5 inches, inwardly from edge 21-1. In this manner, die-cut 35 effectively cuts face portion 21 into a major portion 22-1 and a minor portion 22-2.

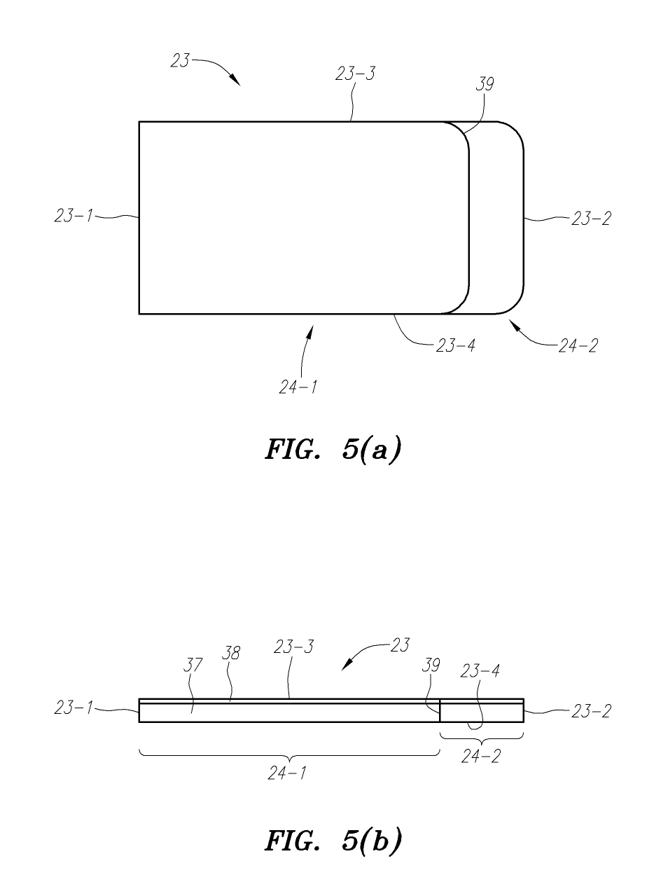

Liner portion 23, which is also shown separately in FIGS. 5(a) and 5(b), can be a generally rectangular, multilayer structure shaped to include an edge 23-1, an edge 23-2, an edge 23-3, and an edge 23-4. Face portion 21 and liner portion 23 are preferably dimensioned so that edges 21-1 through 21-4 of face portion 21 substantially align with edges 23-1 through 23-4, respectively, of liner portion 23. Liner portion 23 can be, but need not be, a release liner, for example, a base sheet 37, such as a paper, and a suitable release coating 38, release coating 38 being applied to the top surface of base sheet 37 in an area that generally corresponds to the layer of adhesive material 31.

Liner portion 23 can further include a die-cut 39 that extends through the thickness of liner portion 23, i.e., through base sheet 37 and release coating 38. Die-cut 39 also extends from edge 23-3 of liner portion 23 to edge 23-4 of liner portion 23, die-cut 39 being spaced a short distance, e.g., approximately 0.5 inches, inwardly from edge 23-2. In this manner, die-cut 39 effectively divides liner portion 23 into a major portion 24-1 and a minor portion 24-2. For reasons to become apparent below, die-cut 39 is preferably positioned so that retaining member 17 is positioned intermediate to die-cut 39 and die-cut 35. Retaining member 17 can be as wide as the entire distance from edges 14-1 through 14-3 of label assemblies 13-1 through 13-3, respectively, to die-cuts 39, or, as in the present embodiment, retaining member 17 can be a narrow band, for example, approximately 0.25 inches in width, spaced between edges 14-1 through 14-3 of label assemblies 13-1 through 13-3, respectively, and die-cuts 39.

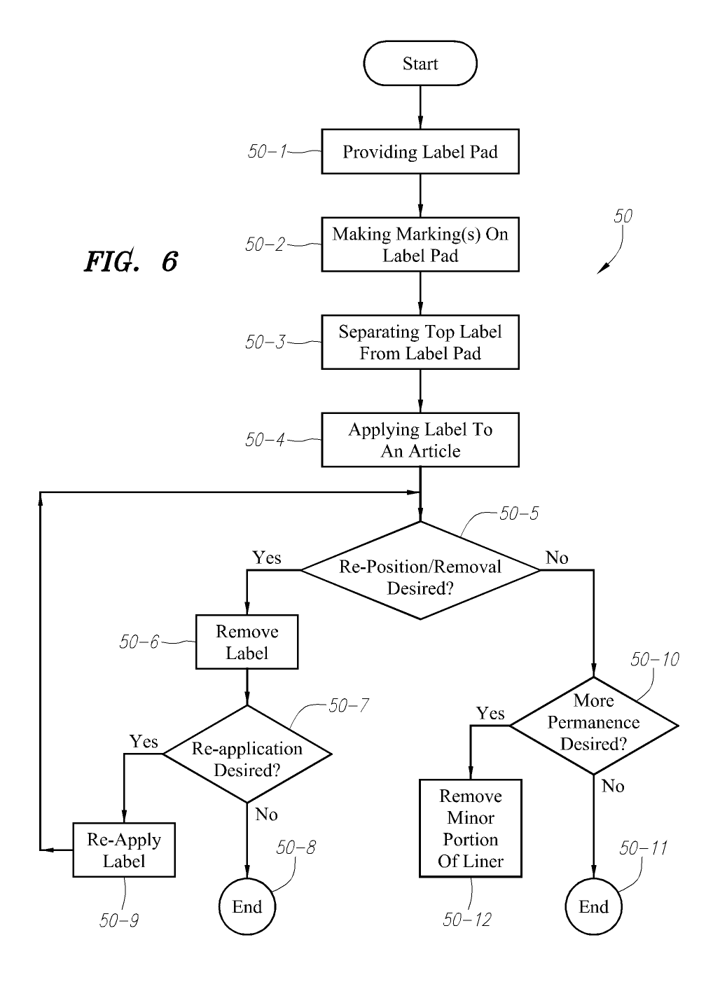

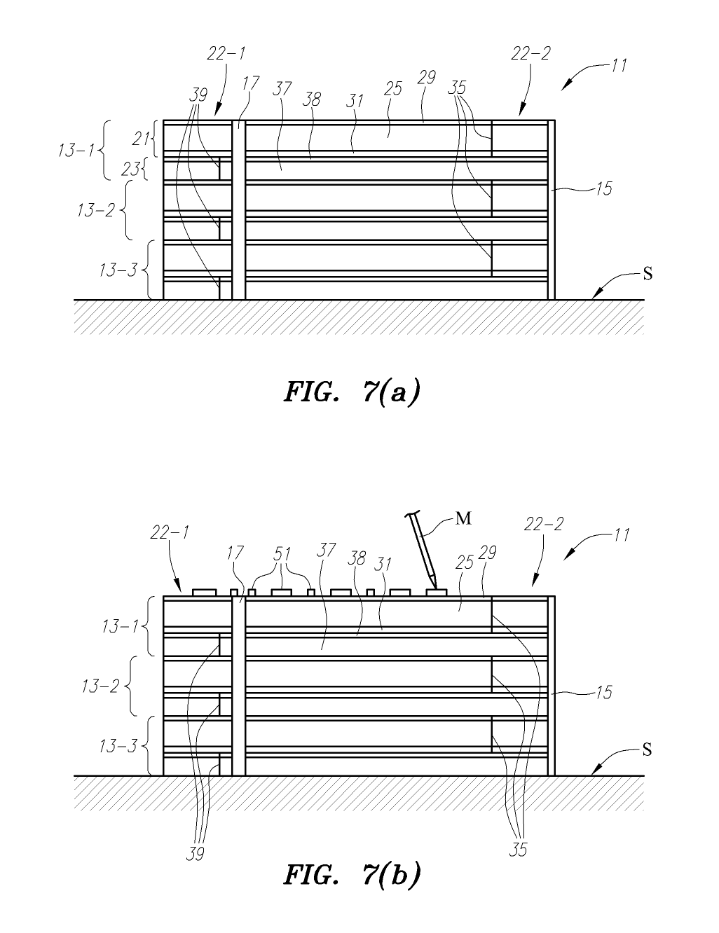

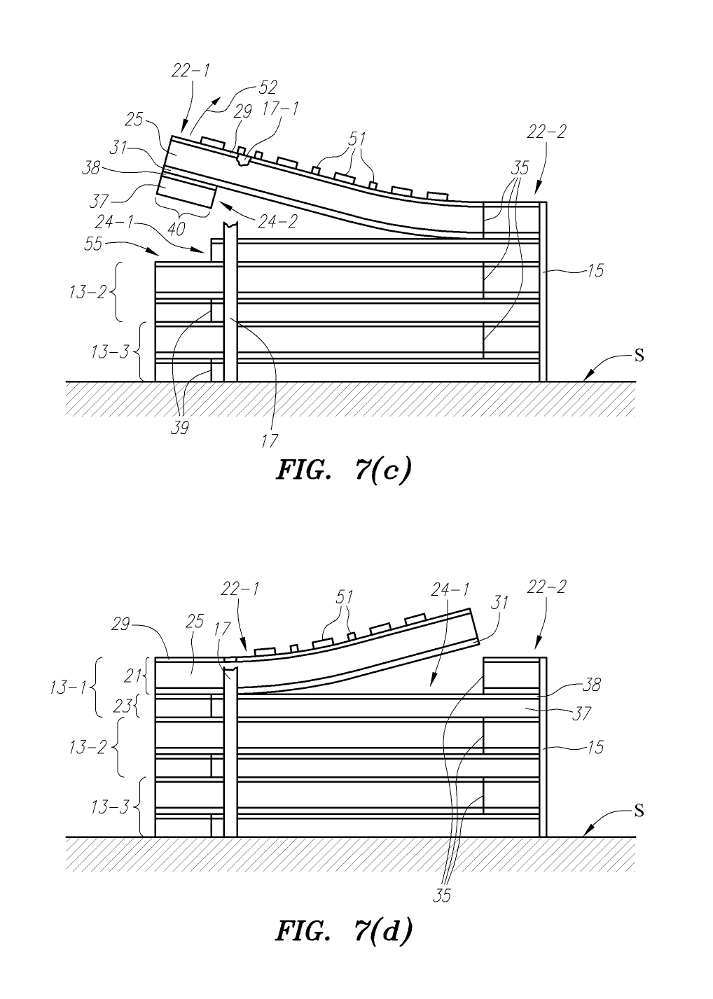

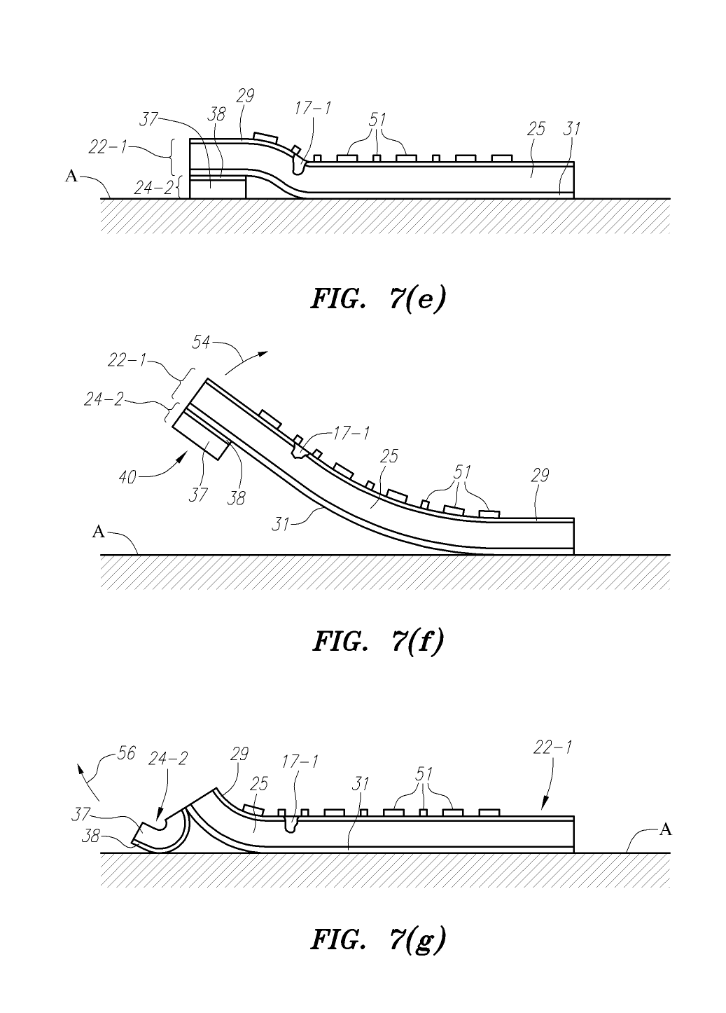

Referring now to FIG. 6, there is shown a flowchart, schematically depicting one method for using label pad 11 according to the present invention, said method being represented generally by reference numeral 50. (In addition, some of the steps of method 50 are also depicted in FIGS. 7(a) through 7(g).) Method 50 can begin in a step 50-1 with the provision of label pad 11, which can, for example, be seated non-adhesively on a surface S (see FIG. 7(a)), such as a countertop, a table top, or in a user's hand. Next, method 50 can continue in a step 50-2 with the making of one or more markings 51 on label assembly 13-1, said markings 51 being made with a suitable marking instrument M (see FIG. 7(b)). Then, method 50 can continue in a step 50-3 with the separation of major portion 22-1 of face portion 21 of label assembly 13-1 from the major portion 24-1 of liner portion 23 of label assembly 13-1 (see FIG. 7(c)). The aforementioned separation of major portion 22-1 from major portion 24-1 can be performed manually, with one of the user's hands being used to peel major portion 22-1 in the direction indicated by arrow 52 (see FIG. 7(c)) and with the other of the user's hands being used to hold the remainder of label pad 11, also known as the support 55, stationary against surface S. As major portion 22-1 is peeled away in the aforementioned manner, retaining member 17 ensures that major portion 24-1 of label assembly 13-1 remains with the support 55; however, it should be noted that, because of die-cut 39, minor portion 24-2 of liner portion 23 of label assembly 13-1 does not remain with the support 55 but, instead, peels away with major portion 22-1, with minor portion 24-2 and the portion of major portion 22-1 overlying minor portion 24-2 together forming a peel tab 40. Also, as major portion 22-1 is peeled away in the above-described manner, a portion 17-1 of retaining member 17 can break off from retaining member 17 and can remain with major portion 22-1 of label assembly 13-1. (It is to be understood that, although FIG. 7(c) shows major portion 22-1 being separated from minor portion 24-2 by peeling major portion 22-1 from the edge that lies distal to padding member 15, major portion 22-1 could alternatively be separated from minor portion 24-2 by peeling away from the edge of major portion 22-1 that lies proximal to padding member 15, as is shown in FIG. 7(d).)

Next, method 50 can continue in a step 50-4 with the application of the thus-separated combination of major portion 22-1 and minor portion 24-2 to a desired article A by directly contacting the article A with the exposed area of the layer of adhesive material 31 (see FIG. 7(e)). If the layer of adhesive material 31 includes a repositionable adhesive, method 50 can continue in a step 50-5 with the user deciding whether or not to reposition or to remove the label after adherence to the article. If repositioning/removal is desired, method 50 can continue in a step 50-6 with the peeling of major portion 22-1 away from article A by grasping peel tab 40 (since peel tab 40 is not adhered to article A) and pulling peel tab 40 away from article A in the direction indicated by arrow 54 (see FIG. 7(f)). Method 50 can then continue in a step 50-7 with the user deciding whether or not to re-adhere major portion 22-1. If no such re-adherence is desired, method 50 can conclude in a step 50-8. On the other hand, if such re-adherence is desired, method 50 can continue in a step 50-9. Then, after step 50-9, method 50 returns to step 50-5. If no further repositioning or removal of the label is desired, method 50 can continue in a step 50-10 with the user deciding whether or not to make the adherence of the label to the article A more permanent. If no additional permanence is desired, method 50 can conclude in a step 50-11. On the other hand, if additional permanence is desired, method 50 can conclude in a step 50-12 with the separation of minor portion 24-2 from major portion 22-1 by peeling minor portion 24-2 away from major portion 22-1 in the direction indicated by arrow 56 and then by adhering to article A the portion of layer of adhesive material 31 that is exposed by the removal of minor portion 24-2 (see FIG. 7(g)).

It is to be noted that, if the layer of adhesive material 31 includes a permanent adhesive, instead of a removable adhesive, method 50 can be modified to omit steps 50-5 through 50-9, with step 50-10 following step 50-4.

Once major portion 22-1 of face portion 21 of label assembly 13-1 has been removed from the remainder of the label pad in the fashion discussed above, one can, if desired, use minor portion 22-2 of label assembly 13-1 as a label by making a marking on minor portion 22-2 and then by peeling minor portion 22-1 away from the remainder of the label pad. Whether or not one wishes to use minor portion 22-2 in this fashion, if one wishes to access label assembly 13-2, one can first remove any remaining portions of label assembly 13-1.

It should be noted that, instead of making markings M on major portion 22-1 of face portion 21 of label assembly 13-1 prior to separating major portion 22-1 of label assembly 13-1 from major portion 24-1 of liner portion 23 of label assembly 13-1, one could alternatively (or additionally) make markings on major portion 22-1 after major portion 22-1 has been separated from the support 55 and has been adhered to an article.

As can be appreciated, because label pad 11 includes a liner, liner pad 11 overcomes the above-described shortcoming of liner-less label pads' need to balance the effectiveness of the release coating and the adhesive strength of the labels. At the same time, as compared to conventional liner-containing label pads, liner pad 11 overcomes the difficulty of removing the top label from its associated liner to expose its adhesive surface.

Referring now to FIGS. 8(a) and 8(b), there are shown top plan and enlarged side elevational views, respectively, of a second embodiment of a label pad constructed according to the present invention, the label pad being represented generally by reference numeral 111.

Label pad 111 can be similar in many respects to label pad 11. However, one notable difference between label pad 11 and label pad 111 is that, whereas label pad 11 can include a plurality of identical label assemblies 13-1 through 13-3 arranged in a stack with corresponding structures aligned with one another, label pad 111 can include a plurality of identical label assemblies 113-1 through 113-3 arranged in a stack with corresponding structures aligned with one another. (It is to be understood that, although label pad 111 is shown in the present embodiment including three label assemblies 113-1 through 113-3, the number of label assemblies shown in label pad 111 is merely exemplary, and label pad 111 can have a greater number or lesser number of label assemblies.)

Each of label assemblies 113-1 through 113-3 can include a face portion 121 and a liner portion 123. Face portion 121 can be a generally rectangular multilayer structure shaped to include a sheet of facestock 125, and can have a marking-receptive coating 129 applied to the top surface of facestock 125, and a layer of adhesive material 131 applied directly to the bottom surface of facestock 125. Facestock 125, coating 129 and the layer of adhesive material 131 can be similar in composition to facestock 25, coating 29 and the layer of adhesive material 31, respectively, of label pad 11.

Face portion 121 can further include a die-cut 135 that extends through the face portion 121, i.e., through coating 129 and facestock 125, and can extend through the layer of adhesive material 131. Die-cut 135 also extends across the width of label assembly 113-1, i.e., from an edge 121-1 to an edge 121-2, die-cut 135 being spaced a short distance from an edge 121-3, for example, approximately 0.5 inches. In this manner, die-cut 135 effectively divides face portion 121 into a major portion 122-1 and a minor portion 122-2.

Liner portion 123 can be a generally rectangular multilayer structure shaped to include a base sheet 137 and a release coating 138, release coating 138 being applied to the top surface of base sheet 137 in an area that generally corresponds to the layer of adhesive material 131. Base sheet 137 and release coating 138 can be similar in composition to base sheet 37 and release coating 38, respectively, of label pad 11. Face portion 121 and liner portion 123 preferably have the same dimensions.

Liner portion 123 can further include a die-cut 139 that extends through the thickness of liner portion 123, i.e., through base sheet 137 and release coating 138. Die-cut 139 also extends the width of label assembly 113-1, i.e., from edge 121-1 to edge 121-2. In addition, die-cut 139 is spaced a short distance relative to die-cut 135, for example, approximately 0.125 inches to approximately 0.5 inches, so that die-cut 135 is positioned at an intermediate point between die-cut 139 and edge 121-3. As such, die-cut 139 effectively divides liner portion 123 into a major portion 124-1 and a minor portion 124-2.

Another notable difference between label pad 111 and label pad 11 is that, whereas label pad 11 can include a padding member 15 positioned along edges 14-1 through 14-3 of label assemblies 13-1 through 13-3, respectively, and a retaining member 17 positioned across edges 18-1 through 18-3 of label assemblies 13-1 through 13-3, respectively, label pad 111 can include a padding member 141 that extends across the respective edges 121-1 of assemblies 113-1 through 113-3 and that is positioned between die-cuts 139 and the respective edges 121-4 of assemblies 113-1 through 113-3, or alternatively, positioned between die-cuts 135 and the respective edges 121-4 of assemblies 113-1 through 113-3.

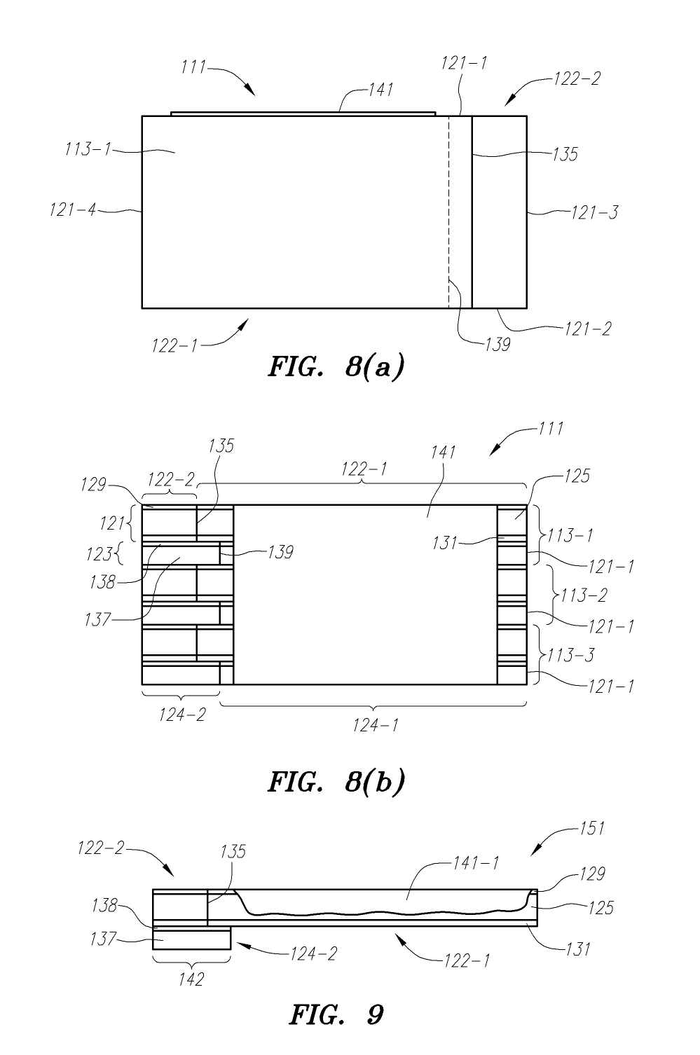

In use, after making whatever markings are desired to major portion 122-1 and/or minor portion 122-2 of top label assembly 113-1, the combination of major portion 122-1, minor portion 122-2 and minor portion 124-2 of top label assembly 113-1 are separated from the remainder of label pad 111. This can be done by peeling pad 111 at top label assembly 113-1 from edge 121-3 to edge 121-4. (Alternatively, this can also be done by peeling pad 111 at top label assembly 113-1 from edge 121-4 to 121-3.) As major portion 122-1 is peeled away in this fashion, padding member 141 serves to retain major portion 124-1 of liner portion 123 of label assembly 113-1 with the remainder of label pad 111. (A portion 141-1 of padding member 141 can break off from padding member 141 and remain on major portion 124-1.) FIG. 9 shows the resulting label assembly, which is represented generally by reference numeral 151. Assembly 151 can be adhered, as is, to an object one wishes to label. Because of the presence of minor portion 124-2, assembly 151, after being adhered to the object, can be repositioned on the object or can be removed from the object, provided that the layer of adhesive material 131 includes a removable or repositionable adhesive, as opposed to a permanent adhesive. Alternatively, one can separate minor portion 124-2 from major portion 122-1 and, at the same time, can also separate minor portion 122-2 from major portion 122-1 by pulling the combination of minor portions 122-2 and 124-2, which can be collectively regarded as a pop tab 142, away from major portion 122-1 until pop tab 142 snaps or “pops” off from major portion 122-1. This can be done, for example, while major portion 122-1 is adhered to the object being labeled so as to enable the separation of minor portions 122-2 and 124-2 to be effected using only one hand. With minor portions 122-2 and 124-2 thus separated from major portion 122-1, minor portion 122-2 can thereafter be used as a small label, complete with its own liner.

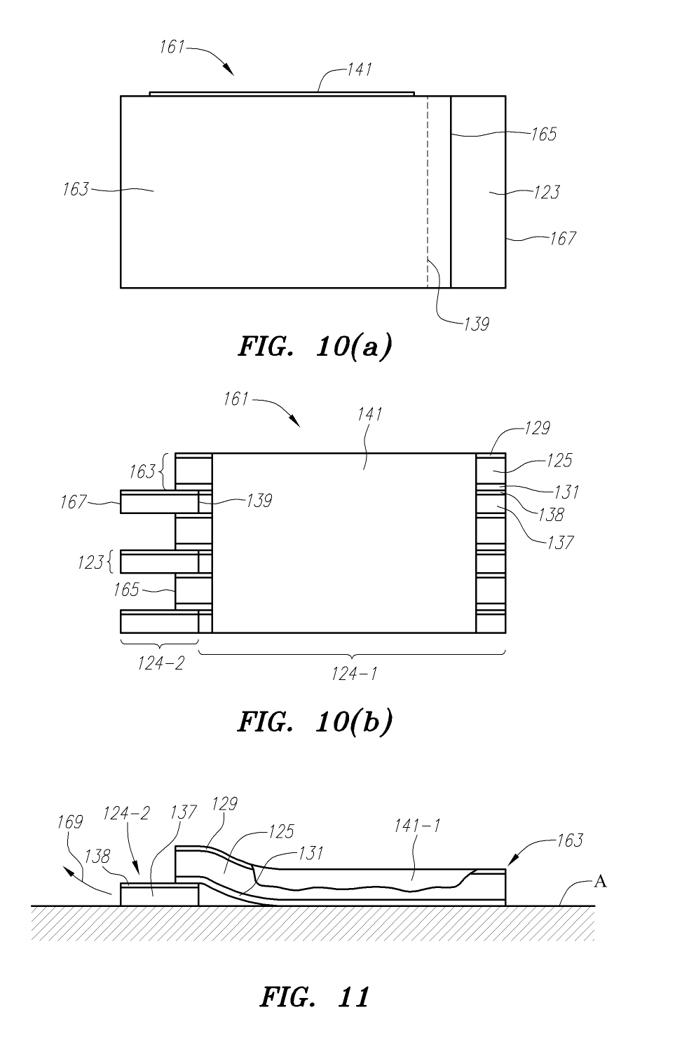

Referring now to FIGS. 10(a) and 10(b), there are shown top plan and enlarged side elevational views, respectively, of a third embodiment of a label pad constructed according to the present invention, the label pad being represented generally by reference numeral 161.

Label pad 161 can be similar in most respects to label pad 111, the principal difference between the two label pads being that label pad 161 does not include a structure corresponding to minor portion 122-2 of label pad 111; consequently, label pad 161 can have a face portion 163 that has the same dimensions as major portion 122-1 of label pad 111. As a result, face portion 163 can have an edge 165 that is positioned intermediate to die-cut 139 of liner portion 123 and an edge 167 of liner portion 123.

Referring now to FIG. 11, there is shown adhered to an article A, the face portion 163 of the top label of pad 161 and its corresponding minor portion 124-2 of liner portion 123. (A portion 141-1 of padding member 141 is also shown adhered to face portion 163.) If one wishes to separate minor portion 124-2 of the liner from face portion 163, leaving face portion 163 adhered to article A, this can be done by pulling minor portion 124-2, which is not, itself, adhered to article A, in the direction indicated by arrow 169.

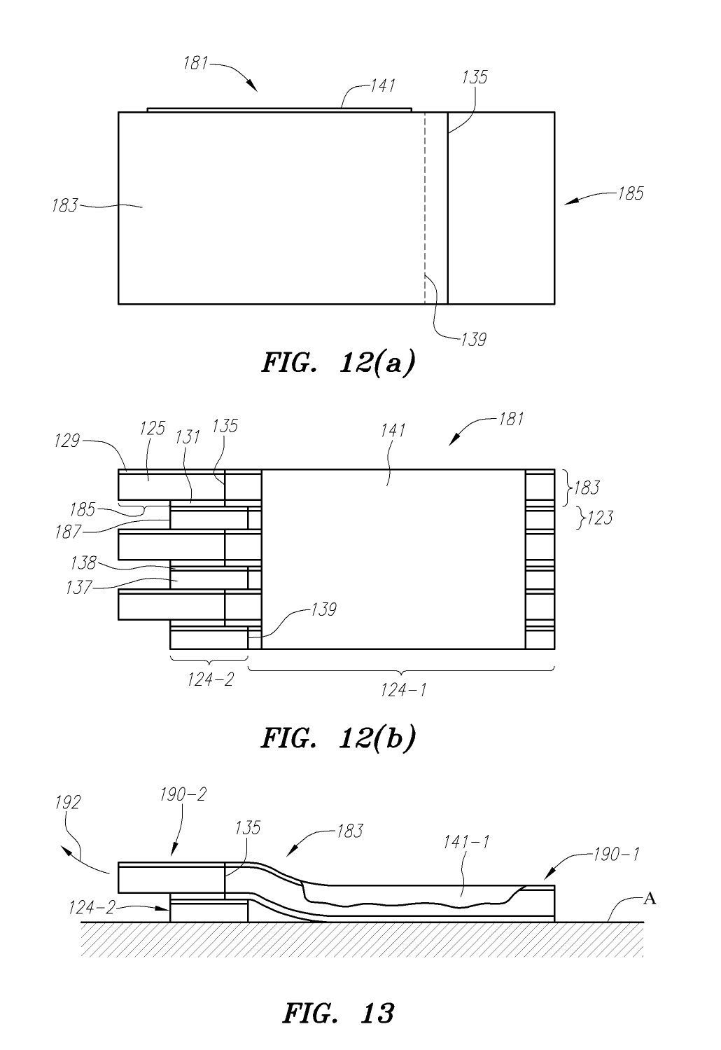

Referring now to FIGS. 12(a) and 12(b), there are shown top plan and enlarged side elevational views, respectively, of a fourth embodiment of a label pad constructed according to the present invention, the label pad being represented generally by reference numeral 181.

Label pad 181 can be similar in most respects to label pad 111, the principal difference between the two label pads being that, whereas label pad 111 can include label portions 121, label pad 181 can instead include label portions 183. Label portions 183 can differ from label portions 121 in that label portions 183 can have an overhang portion 185 that extends a short distance beyond an edge 187 of minor portion 124-2 of liner portion 123 and also in that overhang portions 185 lack the layer of adhesive material 131 on their respective bottom surfaces.

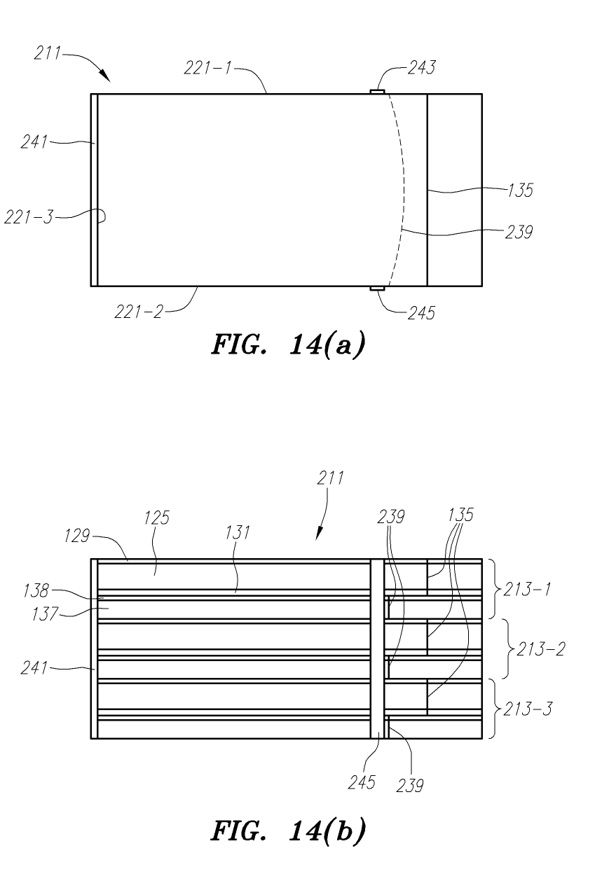

Referring now to FIG. 13, there is shown adhered to an article A, face portion 183 of the top label of pad 181 and its corresponding minor portion 124-2 of liner portion 123. (A portion 141-1 of padding member 141 is also shown adhered to face portion 183.) As can be seen, die-cut 135 divides face portion 183 into a major portion 190-1 and a minor portion 190-2. If one wishes to separate the combination of minor portion 190-2 and minor portion 124-2 from major portion 190-1, leaving major portion 190-1 adhered to article A, this can be done by pulling the combination of minor portion 190-2 and minor portion 124-2 in the direction indicated by arrow 192.

Referring now to FIGS. 14(a) and 14(b), there are shown top plan and enlarged side elevational views, respectively, of a fifth embodiment of a label pad constructed according to the present invention, the label pad being represented generally by reference numeral 211.

Label pad 211 can be similar in many respects to label pad 111, one difference between the two label pads being that, whereas label pad 111 can include a plurality of identical label assemblies 113-1 through 113-3 arranged in a stack with corresponding structures aligned with one another, label pad 211 can include a plurality of identical label assemblies 213-1 through 213-3 arranged in a stack with corresponding structures aligned with one another. (It is to be understood that, although label pad 211 is shown in the present embodiment including three label assemblies 213-1 through 213-3, the number of label assemblies shown in label pad 211 is merely exemplary, and label pad 211 can have a greater number or lesser number of label assemblies.)

Label assemblies 213-1 through 213-3 can be similar in most respects to label assemblies 113-1 through 113-3, the two types of label assemblies differing most notably in that, whereas die-cuts 139 of label assemblies 113-1 through 113-3 extend in a straight line between edge 121-1 and edge 121-2, die-cuts 239 of label assemblies 213-1 through 213-3 extend in an arcuate line between an edge 221-1 of label assemblies 213-1 through 213-3 and an edge 221-2 of label assemblies 213-1 and 213-3.

Another notable difference between label pad 211 and label pad 111 is that, whereas label pad 111 includes padding member 141 extending across the respective edges 121-1 of assemblies 113-1 through 113-3 and positioned in a wide band between die-cuts 139 and the respective edges 121-4 of assemblies 113-1 through 113-3, label pad 211 includes a padding member 241 covering substantially the entire edges 221-3 of assemblies 213-1 through 213-3, a retaining member 243 extending in a narrow band across a portion of the edges 221-1 of assemblies 213-1 through 213-3 between die-cuts 239 and edges 221-3, and a retaining member 245 extending in a narrow band across a portion of the edges 221-2 of assemblies 213-1 through 213-3 between die-cuts 239 and edges 221-3.

Label pad 211 can be used in much the same manner as label pad 111.

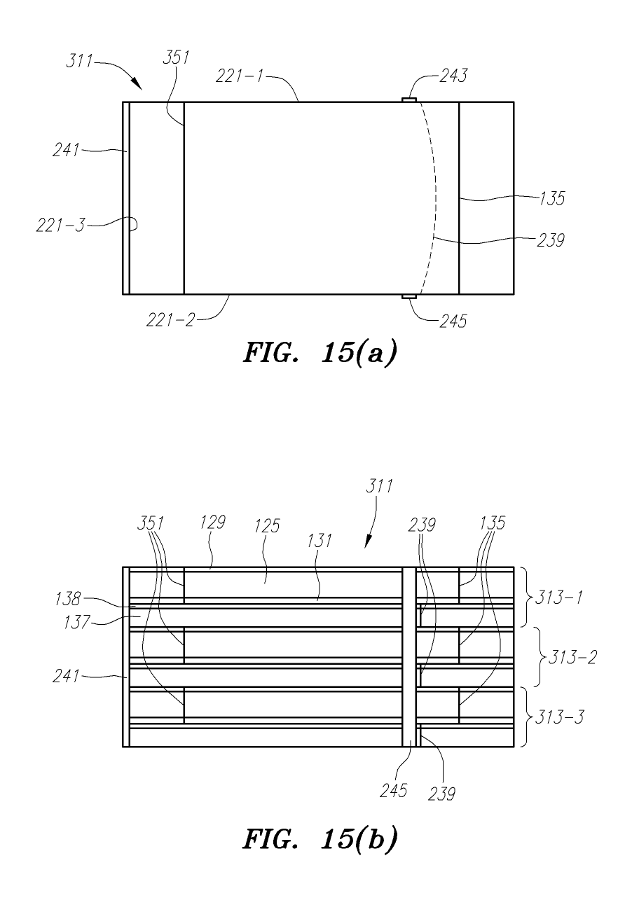

Referring now to FIGS. 15(a) and 15(b), there are shown top plan and enlarged side elevational views, respectively, of a sixth embodiment of a label pad constructed according to the present invention, the label pad being represented generally by reference numeral 311.

Label pad 311 can be similar in many respects to label pad 211, one difference between the two label pads being that, whereas label pad 211 can include a plurality of identical label assemblies 213-1 through 213-3 arranged in a stack with corresponding structures aligned with one another, label pad 311 can include a plurality of identical label assemblies 313-1 through 313-3 arranged in a stack with corresponding structures aligned with one another. (It is to be understood that, although label pad 311 is shown in the present embodiment including three label assemblies 313-1 through 313-3, the number of label assemblies shown in label pad 311 is merely exemplary, and label pad 311 can have a greater number or lesser number of label assemblies.)

Label assemblies 313-1 through 313-3 can be similar in most respects to label assemblies 213-1 through 213-3, the two types of label assemblies differing most notably in that each of label assemblies 313-1 through 313-3 additionally includes a die-cut 351 that extends through the thickness of coating 129 and facestock 125, and can extend through the layer of adhesive material 131 and that extends from edge 221-1 to edge 221-2, die-cut 351 being spaced a short distance from edge 221-3, for example, approximately 0.5 inches.

Label pad 311 can be used in much the same manner as label pad 211, except that, due to the presence of die-cut 351, after a label has been separated, a small piece of the face portion of the label assembly is left behind attached to web 241.

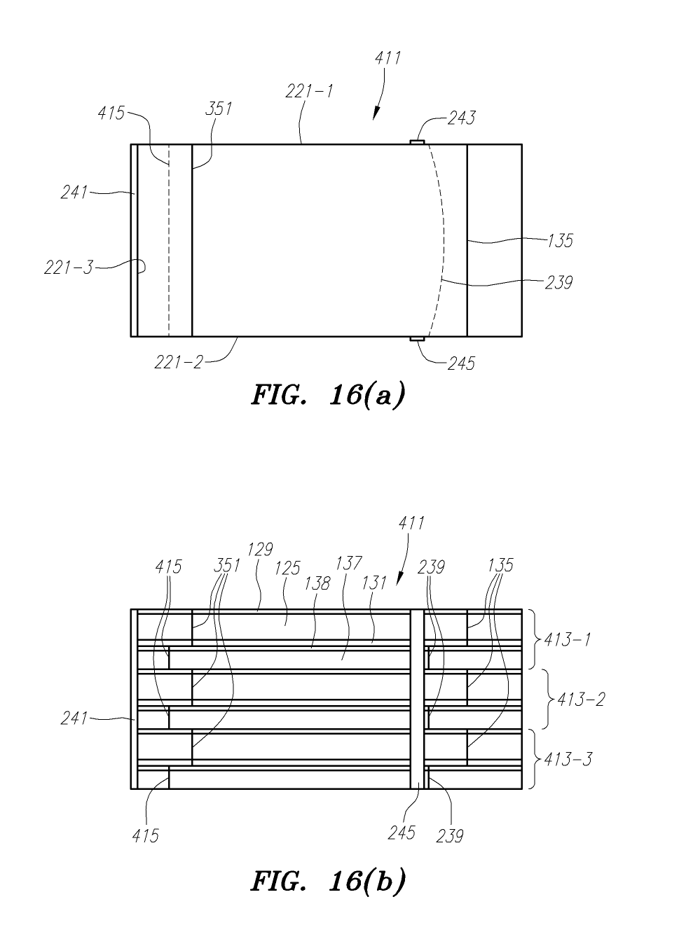

Referring now to FIGS. 16(a) and 16(b), there are shown top plan and enlarged side elevational views, respectively, of a seventh embodiment of a label pad constructed according to the present invention, the label pad being represented generally by reference numeral 411.

Label pad 411 can be similar in many respects to label pad 311, one difference between the two label pads being that, whereas label pad 311 can include a plurality of identical label assemblies 313-1 through 313-3 arranged in a stack with corresponding structures aligned with one another, label pad 411 can include a plurality of identical label assemblies 413-1 through 413-3 arranged in a stack with corresponding structures aligned with one another. (It is to be understood that, although label pad 411 is shown in the present embodiment including three label assemblies 413-1 through 413-3, the number of label assemblies shown in label pad 411 is merely exemplary, and label pad 411 can have a greater number or lesser number of label assemblies.)

Label assemblies 413-1 through 413-3 can be similar in most respects to label assemblies 313-1 through 313-3, the two types of label assemblies differing most notably in that each of label assemblies 413-1 through 413-3 can additionally include a die-cut (or perforation or other separation line) 415 that extends through the thickness of release coating 138 and base sheet 137 and that extends from edge 221-1 to edge 221-2, die-cut 415 being positioned at an intermediate location relative to edge 221-3 and die-cut 351.

Label pad 411 can be used in much the same manner as label pad 311, except that, due to the presence of die-cut 415, after a label has been separated, the piece of the liner portion retained on the pad by members 241, 243 and 245 can be removed simply by pulling on the liner portion piece until it snaps or “pops” off from the remaining piece of the face portion positioned thereover. (It should be noted that, in contrast with the embodiments described above, which get thinner at the end of padding member 241, as label structures are removed, the present embodiment maintains its original thickness at the end of padding member 241.)

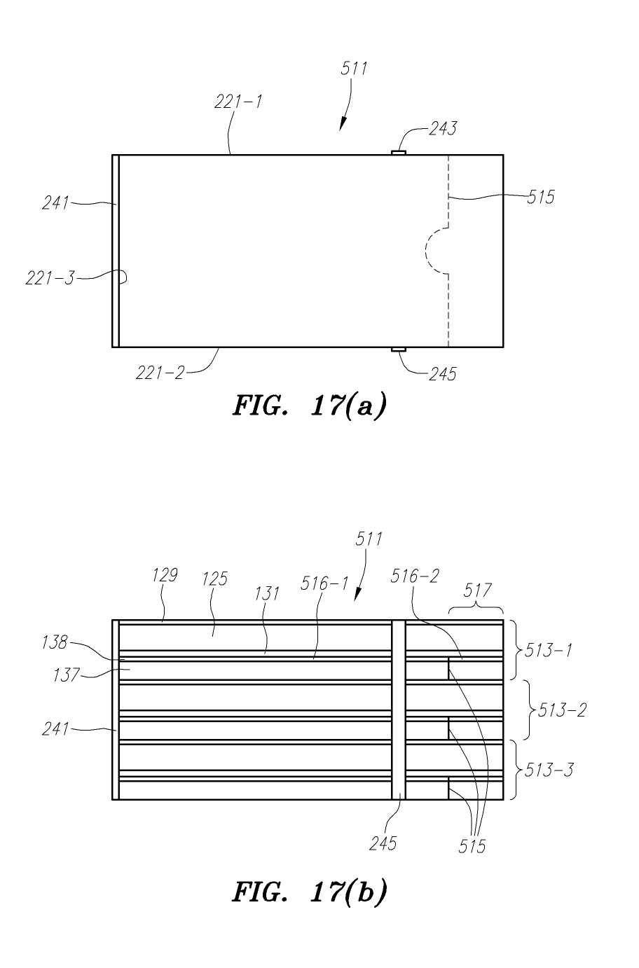

Referring now to FIGS. 17(a) and 17(b), there are shown top plan and enlarged side elevational views, respectively, of an eighth embodiment of a label pad constructed according to the present invention, the label pad being represented generally by reference numeral 511.

Label pad 511 can be similar in many respects to label pad 211, one difference between the two label pads being that, whereas label pad 211 can include a plurality of identical label assemblies 213-1 through 213-3 arranged in a stack with corresponding structures aligned with one another, label pad 511 can include a plurality of identical label assemblies 513-1 through 513-3 arranged in a stack with corresponding structures aligned with one another. (It is to be understood that, although label pad 511 is shown in the present embodiment including three label assemblies 513-1 through 513-3, the number of label assemblies shown in label pad 511 is merely exemplary, and label pad 511 can have a greater number or lesser number of label assemblies.)

Label assemblies 513-1 through 513-3 can be similar in most respects to label assemblies 213-1 through 213-3, the two types of label assemblies differing most notably in that, whereas each of label assemblies 213-1 through 213-3 includes a die-cut 135, label assemblies 513-1 through 513-3 do not include any structure corresponding to die cut 135. In addition, label assemblies 513-1 through 513-3 also differ from label assemblies 213-1 through 213-3 in that, whereas each of label assemblies 213-1 through 213-3 includes a die-cut 239, each of label assemblies 513-1 through 513-3 instead includes a die-cut 515 in the liner portion that defines a major portion 516-1 and a minor portion 516-2. Die-cut 515 can be shaped so that minor portion 516-2 and the portion of the face portion overlying minor portion 516-2 collectively define a peel tab 517.

Label pad 511 can be used in much the same manner as label pad 211, except that, in using label pad 511, one can remove the piece of liner adhered to the bottom of the label by peeling the piece of liner away from the label, for example, see FIG. 7(g), as opposed to “popping” the piece of liner off the label.

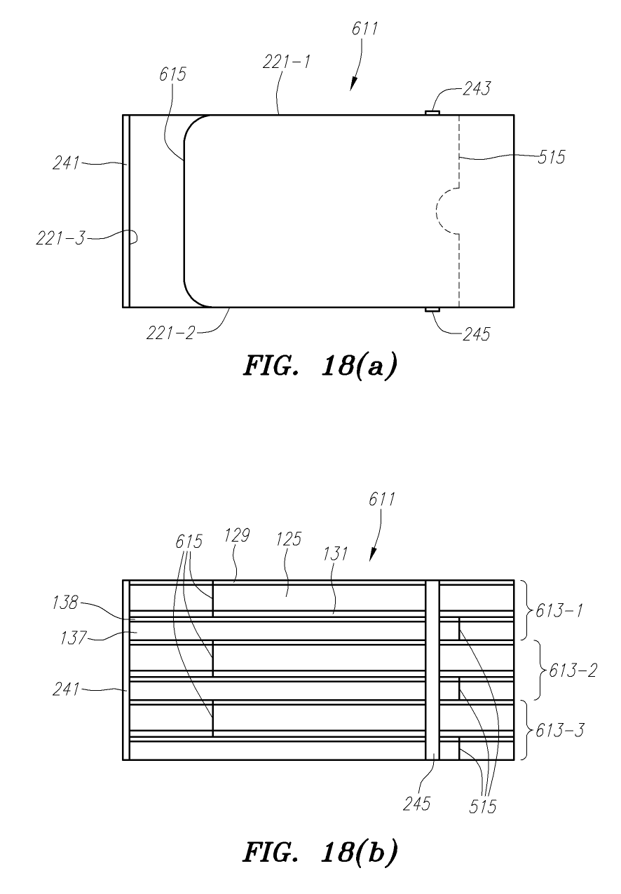

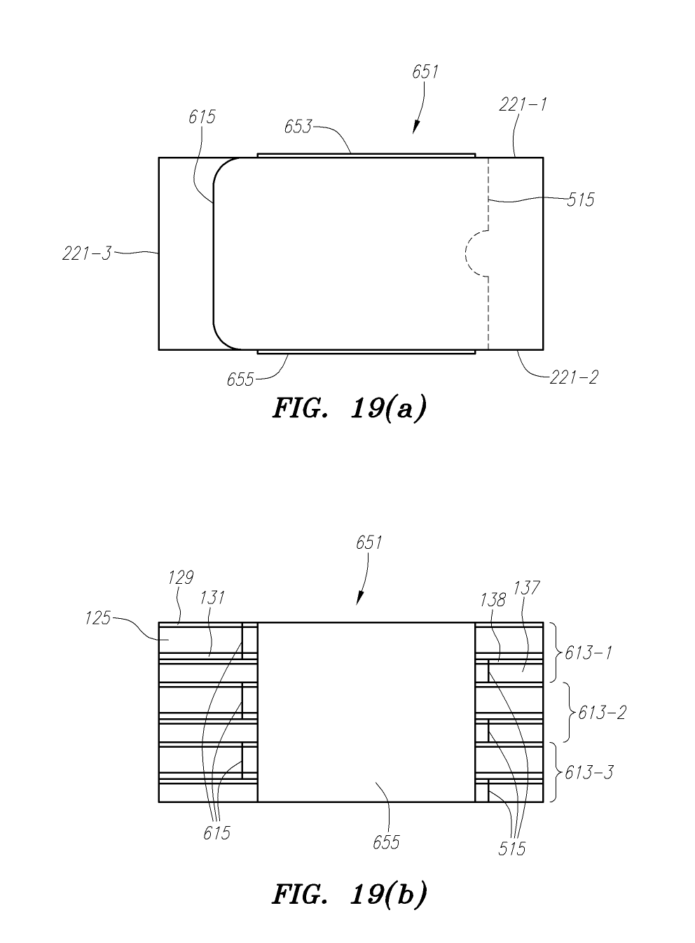

Referring now to FIGS. 18(a) and 18(b), there are shown top plan and enlarged side elevational views, respectively, of a ninth embodiment of a label pad constructed according to the present invention, the label pad being represented generally by reference numeral 611.

Label pad 611 can be similar in many respects to label pad 511, one difference between the two label pads being that, whereas label pad 511 can include a plurality of identical label assemblies 513-1 through 513-3 arranged in a stack with corresponding structures aligned with one another, label pad 611 can include a plurality of identical label assemblies 613-1 through 613-3 arranged in a stack with corresponding structures aligned with one another. (It is to be understood that, although label pad 611 is shown in the present embodiment including three label assemblies 613-1 through 613-3, the number of label assemblies shown in label pad 611 is merely exemplary, and label pad 611 can have a greater number or lesser number of label assemblies.)

Label assemblies 613-1 through 613-3 can be similar in most respects to label assemblies 513-1 through 513-3, the two types of label assemblies differing most notably in that, each of label assemblies 613-1 through 613-3 can additionally include a die-cut 615 that extends through the thickness of coating 129 and facestock 125, and can extend through the layer of adhesive material 131 and that extends from edge 221-1 to edge 221-2, die-cut 615 being spaced a short distance inwardly from edge 221-3, for example, approximately 0.5 inches.

Label pad 611 can be used in much the same manner as label pad 511, except that, due to the presence of die-cut 615, after a label has been removed, a small piece of the face portion of the label assembly is left behind attached to web 241.

Referring now to FIGS. 19(a) and 19(b), there are shown top plan and enlarged side elevational views, respectively, of a tenth embodiment of a label pad constructed according to the present invention, the label pad being represented generally by reference numeral 651.

Label pad 651 can be similar in many respects to label pad 611, one difference between the two label pads being that, whereas label pad 611 can include padding member 241 along edges 221-3, retaining member 243 extending in a narrow band along edges 221-1, and retaining member 245 extending in a narrow band along edges 221-2, label pad 651 does not include a padding member along edges 221-3 but can include a padding member 653 extending along edges 221-1 in a wide band between die-cut 615 and die-cut 515 and can include a padding member 655 extending along edges 221-2 in a wide band between die-cut 615 and die-cut 515. Alternatively, padding member 653 and padding member 655 can extend the entire length of edges 221-1 and 221-2, respectively.

Label pad 651 can be used in much the same manner as label pad 611. Moreover, label pad 651 is well-suited for a “Z” arrangement of its constituent label assemblies, wherein each label assembly is rotated 180 degrees relative to its adjacent label assemblies.

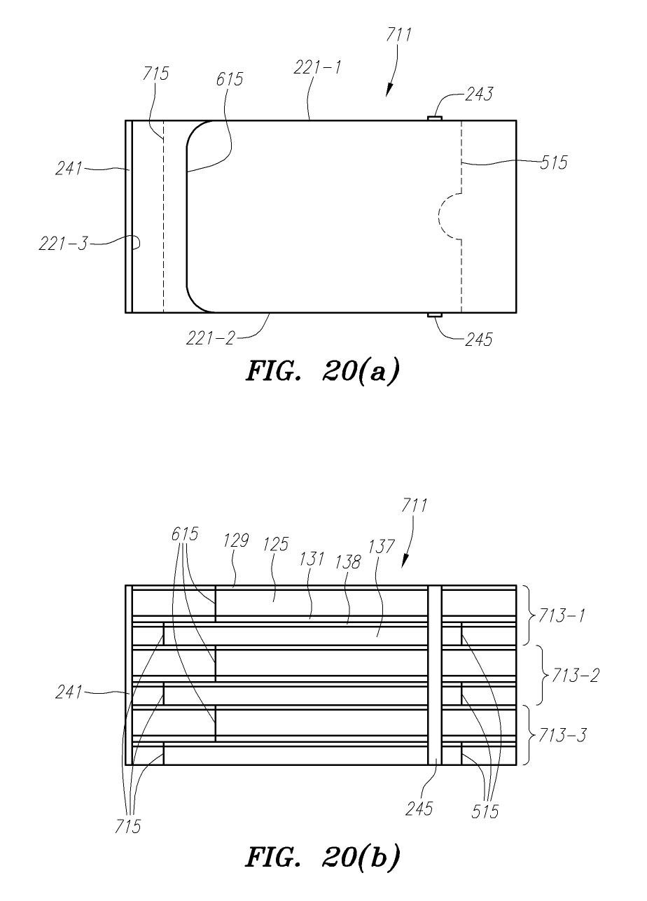

Referring now to FIGS. 20(a) and 20(b), there are shown top plan and enlarged side elevational views, respectively, of an eleventh embodiment of a label pad constructed according to the present invention, the label pad being represented generally by reference numeral 711.

Label pad 711 can be similar in many respects to label pad 611, one difference between the two label pads being that, whereas label pad 611 can include a plurality of identical label assemblies 613-1 through 613-3 arranged in a stack with corresponding structures aligned with one another, label pad 711 can include a plurality of identical label assemblies 713-1 through 713-3 arranged in a stack with corresponding structures aligned with one another. (It is to be understood that, although label pad 711 is shown in the present embodiment including three label assemblies 713-1 through 713-3, the number of label assemblies shown in label pad 711 is merely exemplary, and label pad 711 can have a greater number or lesser number of label assemblies.)

Label assemblies 713-1 through 713-3 can be similar in most respects to label assemblies 613-1 through 613-3, the two types of label assemblies differing most notably in that, each of label assemblies 713-1 through 713-3 can additionally include a die-cut 715 that extends through the thickness of release coating 138 and base sheet 137 and that extends from edge 221-1 to edge 221-2, die-cut 715 being spaced at a location intermediate to edge 221-3 and die-cut 615.

Label pad 711 can be used in much the same manner as label pad 611, except that, due to the presence of die-cut 715, after a label has been removed, the piece of the liner portion retained on the pad by members 243 and 245 can be removed simply by pulling on the liner portion piece until it snaps or “pops” off from the remaining piece of the face portion positioned thereover.

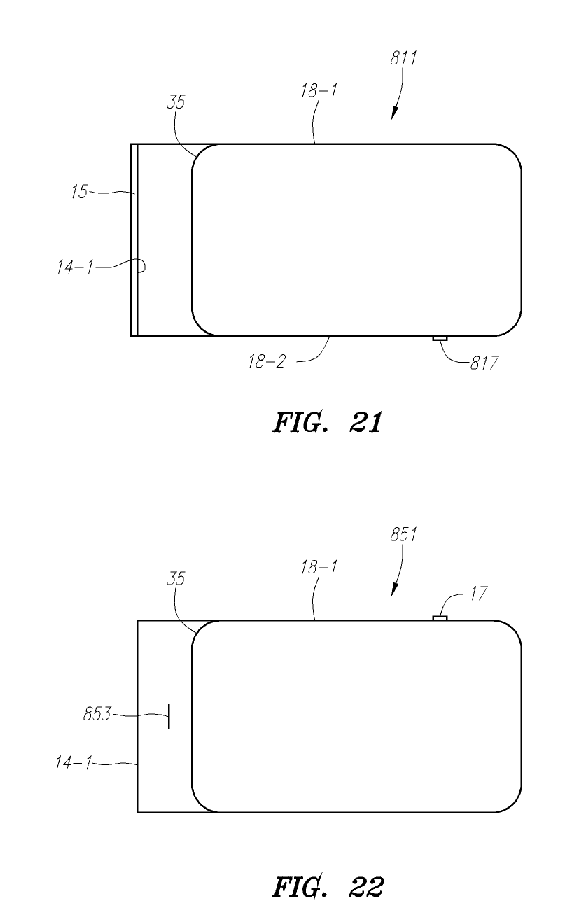

Referring now to FIG. 21, there is shown a top plan view of a twelfth embodiment of a label pad constructed according to the present invention, the label pad being represented generally by reference numeral 811.

Label pad 811 can be similar in many respects to label pad 11, the principal difference between the two label pads being that, whereas label pad 11 can include retaining member 17 along edge 18-1, label pad 811 can include a retaining member 817 along an edge 18-2. Retaining member 817 can be identical in composition and function to retaining member 17.

Label pad 811 can be used in much the same manner as label pad 11.

Referring now to FIG. 22, there is shown a top plan view of a thirteenth embodiment of a label pad constructed according to the present invention, the label pad being represented generally by reference numeral 851.

Label pad 851 can be similar in many respects to label pad 11, the principal difference between the two label pads being that, whereas label pad 11 can include padding member 15 to mechanically couple together its constituent label assemblies, label pad 851 can instead include at least one staple 853 for mechanically coupling together its constituent label assemblies.

Label pad 851 can be used in much the same manner as label pad 11.

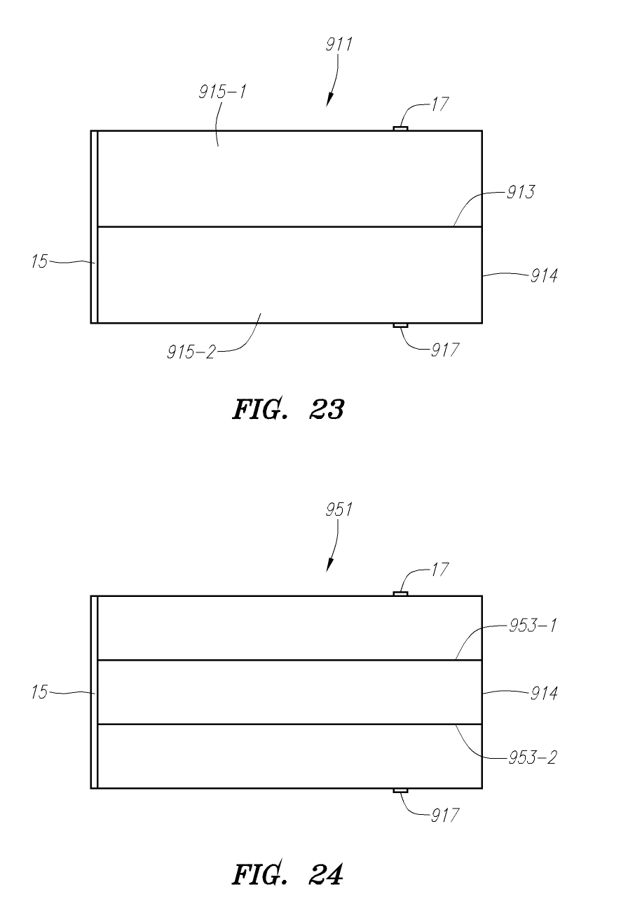

Referring now to FIG. 23, there is shown a top plan view of a fourteenth embodiment of a label pad constructed according to the present invention, the label pad being represented generally by reference numeral 911.

Label pad 911 can be similar in many respects to label pad 11, one difference between the two pads being that label pad 911 can additionally include a die-cut 913, die-cut 913 extending away from padding member 15 to an opposite edge 914 and extending entirely through all of its label assemblies to create equally-dimensioned first and second label assembly stacks 915-1 and 915-2, stacks 915-1 and 915-2 being disposed side-by-side to one another and being commonly coupled to padding member 15. Another difference between label pad 911 and label pad 11 is that label pad 911 can additionally include a retaining member 917, retaining member 917 being disposed on stack 915-2 in a manner analogous to that of retaining member 17 on stack 915-1.

Label pad 911 can be used in much the same manner as label pad 11, except that stacks 915-1 and 915-2 can be used independently of one another.

Referring now to FIG. 24, there is shown a top plan view of a fifteenth embodiment of a label pad constructed according to the present invention, the label pad being represented generally by reference numeral 951.

Label pad 951 can be similar in many respects to label pad 911, one difference between the two label pads being that, whereas label pad 911 can include a single die-cut 913 that extends away from padding member 15 to opposite edge 914 and that extends entirely through all of its label assemblies to define stacks 915-1 and 915-2, label pad 951 can include a pair of die-cuts 953-1 and 953-2. Each of die-cuts 953-1 and 953-2 can extend entirely from padding member 15 to opposite edge 914. However, unlike die-cut 913, die-cuts 953-1 and 953-2 preferably do not extend entirely through all of the label assemblies of pad 951. Instead, each of die-cuts 953-1 and 953-2 preferably extends only through the face portions of the respective label assemblies and does not extend through the liner portions of the respective label assemblies. (Alternatively, die-cuts 953-1 and 953-2 could extend entirely through all of the label assemblies if label pad 951 additionally includes a carrier card to which the three stacks are secured, and a retaining member is provided for the middle stack.)

Label pad 951 can be used in much the same manner as label pad 911, except for the fact that the face portions of the three stacks share common liner portions.

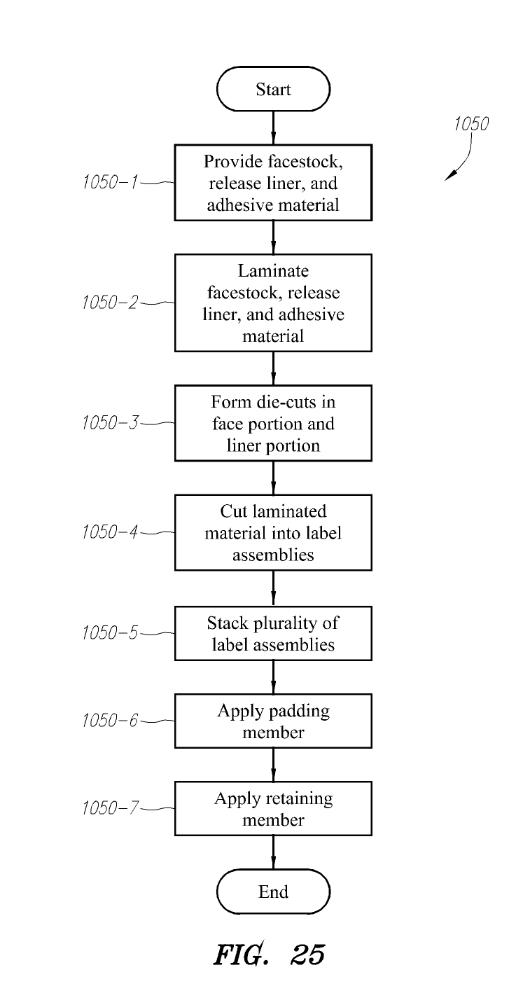

Referring now to FIG. 25, there is shown a flowchart, schematically depicting one method of manufacturing label pad 11 according to the present invention, said method being represented generally by reference numeral 1050. Method 1050 can begin in a step 1050-1 with the provision of a facestock 25 laminated to release liner that includes a base sheet 37 and release coating 38. Next, method 1050 can continue in step 1050-2 by laminating the facestock 25 to the release liner with a layer of adhesive material 31, forming face portion 21 and liner portion 23. Method 1050 can continue in step 1050-3 by forming die-cut 35 in the face portion 21 and die-cut 39 in the liner portion. Method 1050 can continue in step 1050-4 in which the laminated material is cut into a plurality of label assemblies 13-1 through 13-3. Next, method 1050 can continue in a step 1050-5 by stacking the plurality of label assemblies 13-1 through 13-3 to form a stack of label assemblies. Following step 1050-5, method 1050 can continue in a step 1050-6 by applying padding member 15 to the edges 14-1 through 14-3 of the label assemblies 13-1 through 13-3. Method 1050 can continue in a step 1050-7 with the application of retaining member 17 across a portion of edges 18-1 through 18-3 of label assemblies 13-1 through 13-3.

It should be noted that, although the labels of the various label pads shown herein are generally rectangular in shape, the present invention is not limited to label pads including labels that are generally rectangular in shape and that label pads including labels of other shapes, such as circular, triangular, and other polygonal-shapes, are contemplated as falling within the scope of the present invention.

All features disclosed in the specification, including the claims, abstract, and drawings, and all steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise. Thus, unless expressly stated otherwise, each feature disclosed is one example only of a generic series of equivalent or similar features.

The foregoing detailed description of the present invention is provided for purposes of illustration, and it is not intended to be exhaustive or to limit the invention to the particular embodiments disclosed. The embodiments may provide different capabilities and benefits, depending on the configuration used to implement the key features of the invention. Accordingly, the scope of the invention is defined only by the following claims.

We claim:

1. A label pad comprising:
(a) a first label assembly, the first label assembly including:
(i) a first liner portion, and
(ii) a first face portion positioned over the first liner portion and releasably coupled thereto;
(b) a support, the first label assembly positioned over the support; and
(c) a first retaining member configured to couple at least a portion of the first liner portion of the first label assembly to the support sufficiently to restrain the at least a portion of the first liner portion from separating from the support when the first face portion is peeled away from the support.

2. The label pad as claimed in claim 1, wherein the support includes a second label assembly, the second label assembly including a second liner portion and a second face portion, the second face portion positioned over the second liner portion and releasably coupled thereto.

3. The label pad as claimed in claim 2, wherein the second face portion is positioned directly under the first liner portion.

4. The label pad as claimed in claim 1, wherein the support includes a plurality of identical label assemblies stacked directly on top of one another, each of the identical label assemblies including a liner portion and a face portion, the face portion positioned over the liner portion and releasably coupled thereto.

5. The label pad as claimed in claim 4, wherein the first label assembly is identical to each of the plurality of identical label assemblies.

6. The label pad as claimed in claim 1, wherein the first retaining member includes a padding compound.

7. The label pad as claimed in claim 6, wherein the padding compound is applied to an outside edge of the first liner portion and to an outside edge of the support.

8. The label pad as claimed in claim 1, wherein the first face portion includes a sheet of facestock and an adhesive material, the sheet of facestock having a top surface and a bottom surface, the adhesive material applied to at least a portion of the bottom surface of the sheet of facestock.

9. The label pad as claimed in claim 8, wherein the sheet of facestock includes paper.

10. The label pad as claimed in claim 8, wherein the first face portion further comprises a marking-receptive coating applied to at least a portion of the top surface of the sheet of facestock.

11. The label pad as claimed in claim 1, wherein the first liner portion is divided by a first die-cut into two separate liner portions, one of the two separate liner portions coupled to the first retaining member.

12. The label pad as claimed in claim 1, wherein the first liner portion is divided by first and second die-cuts into three separate portions, one of the three separate portions coupled to the first retaining member.

13. The label pad as claimed in claim 1, wherein the first face portion is divided by a first die-cut into two separate face portions.

14. The label pad as claimed in claim 1, wherein the first face portion is divided by first and second die-cuts into three separate face portions.

15. A label pad comprising:
(a) a stack of identical label assemblies, the stack of identical label assemblies including a top label assembly, each of the identical label assemblies including:
(i) a liner portion, and
(ii) a face portion, the face portion positioned over the liner portion and releasably coupled thereto, the face portion being adhesively-backed and marking-receptive; and
(b) a first retaining member is configured to couple together the stack of identical label assemblies, the first retaining member restraining at least a portion of the liner portion of the top label assembly from separating from the remainder of the stack when a portion of the face portion of the top label assembly is peeled away from the stack.

16. The label pad as claimed in claim 15, wherein each of the identical label assemblies is generally rectangular in shape and includes a first edge, a second edge, a third edge, and a fourth edge.

17. The label pad as claimed in claim 16, wherein the first retaining member extends across the first edges of the respective identical label assemblies.

18. The label pad as claimed in claim 16, further comprising a second retaining member configured to couple together the stack of identical label assemblies, the second retaining member extending across the second edges of the respective identical label assemblies.

19. The label pad as claimed in claim 15, wherein the liner portion is divided by a first die-cut into two separate liner portions, one of the two separate liner portions coupled to the first retaining member.

20. The label pad as claimed in claim 15, wherein the liner portion is divided by first and second die-cuts into three separate liner portions, one of the three separate liner portions coupled to the first retaining member.

21. The label pad as claimed in claim 15, wherein the face portion is divided by a first die-cut into two separate face portions.

22. The label pad as claimed in claim 15, wherein the face portion is divided by first and second die-cuts into three separate face portions.

23. The label pad as claimed in claim 15, wherein:
(a) each of the identical label assemblies is generally rectangular in shape and includes a first side edge, a second side edge, a top edge, and a bottom edge;
(b) the first retaining member extends in a band across the top edges of the respective identical label assemblies, the band spaced inwardly a short distance from the second side edges of the respective identical label assemblies;
(c) the face portion is divided by a first die-cut into two separate face portions, the first die-cut spaced intermediate to the first retaining member and the first side edges of the respective identical label assemblies; and
(d) wherein the liner portion is divided by a second die-cut into two separate liner portions, the second die-cut spaced intermediate to the first retaining member and the second side edges of the respective label assemblies.

24. The label pad as claimed in claim 15, wherein:
(a) each of the identical label assemblies is generally rectangular in shape and includes a first side edge, a second side edge, a top edge, and a bottom edge;
(b) the first retaining member extends in a band across the top edges of the respective identical label assemblies, the band spaced a short distance from the second edges of the respective identical label assemblies;
(c) the face portion is divided by a first die-cut into two separate face portions, the first die-cut positioned intermediate to the first retaining member and the second edges of the respective identical label assemblies; and
(d) the liner portion is divided by a second die-cut into two separate liner portions, the second die-cut positioned intermediate to the first retaining member and the first die-cut.

25. The label pad as claimed in claim 24, further comprising a second retaining member coupling together the stack of identical label assemblies, the second retaining member extending across the first side edges of the respective identical label assemblies.

26. The label pad as claimed in claim 25, wherein the face portion is further divided by a third die-cut into three separate face portions, the third die-cut positioned intermediate to the first side edges of the respective identical label assemblies and the first retaining member.

27. The label pad as claimed in claim 26, wherein the liner portion is further divided by a fourth die-cut into three separate liner portions, the fourth die-cut positioned intermediate to the first side edges of the respective identical label assemblies and the third die-cut.

28. The label pad as claimed in claim 15, wherein:
(a) each of the identical label assemblies is generally rectangular in shape and includes a first side edge, a second side edge, a top edge, and a bottom edge;
(b) the first retaining member extends in a band across the top edges of the respective identical label assemblies, the band spaced a short distance from the second side edges of the respective identical label assemblies; and
(c) the liner portion is divided by a first die-cut into two separate liner portions, the first die-cut positioned intermediate to the first retaining member and the second side edges of the respective identical label assemblies.

29. The label pad as claimed in claim 28, further comprising a second retaining member coupling together the stack of identical label assemblies, the second retaining member extending across the first side edges of the respective identical label assemblies.

30. The label pad as claimed in claim 29, wherein the face portion is divided by a second die-cut into two separate face portions, the second die-cut positioned intermediate to the first side edges of the respective identical label assemblies and the first retaining member.

31. The label pad as claimed in claim 30, wherein the liner portion is further divided by a third die-cut into three separate liner portions, the third die-cut positioned intermediate to first side edges of the respective identical label assemblies and the second die-cut.

32. A method for manufacturing a label pad, the method comprising:
(a) providing a facestock, a release liner, and an adhesive material;
(b) laminating the facestock to the release liner with the adhesive material to form a laminated material having a face portion and a liner portion;
(c) forming die-cuts in the face portion and the liner portion;
cutting the laminated material into label assemblies;
(d) stacking the label assemblies to form a stack of label assemblies having a first edge and a second edge;
(e) applying a padding member to the first edge; and
(f) applying a retaining member to the second edge.
